(19) United States
(12) Patent Application Publication
(10) Pub. No.: US 2015/0361876 A1
(43) Pub. Date: Dec. 17, 2015

(54) HYDROGEN FLUSHED COMBUSTION CHAMBER

(71) Applicant: Caterpillar Energy Solutions GmbH, Mannheim (DE)

(72) Inventor: Michele SCHILIRÒ, Gomadingen (DE)

(73) Assignee: Caterpillar Energy Solutions GmbH, Mannheim (DE)

(21) Appl. No.: 14/760,979

(22) PCT Filed: Jan. 16, 2013
(86) PCT No.: PCT/EP2013/050756

§ 371 Date: Jul. 14, 2015

(51) Int. Cl. F02B 43/12; F02M 25/07; F02M 25/12; C01B 3/36; F02B 39/04; F02G 5/02; F02M 21/04; B01J 19/24; F02B 67/08; F02C 6/00

(52) U.S. Cl. CPC F02B 43/12; F02B 67/08; F02M 25/0742; F02M 25/12; F02C 6/00; F02B 39/04; F02G 5/02; F02M 21/04; B01J 19/24; C01B 3/36; F05B 2220/60; B01J 2219/00157; B01J 2219/24; C01B 2203/0216

(57) ABSTRACT

A method for operating an engine is disclosed. The method may include supplying the engine with gas. The method may also include supplying the engine with hydrogen from a hydrogen source. Further the method may include charging a combustion chamber of the engine with a first amount of loaded gas, which may include a gas air mixture. The method may also include delivering, to the combustion chamber, a second amount of hydrogen. The second amount may be a predetermined fraction X of the first amount. The predetermined fraction may be selected to achieve a predetermined ratio λ of an actual amount of the air in the combustion chamber and a stoichiometric amount of the air in the combustion chamber. The hydrogen and the loaded gas may form a loaded gas mixture in the combustion chamber. The method may also include igniting the loaded gas mixture in the combustion chamber.

### TECHNICAL FIELD

The present invention relates to a procedure for running a spark-ignited gas engine with a combustion chamber and with a hydrogen source, said source supplying the engine with hydrogen, whereby the combustion chamber is being loaded with a gas air mixture.

### Background

EP 0 770 171 B1 discloses ignition devices for internal combustion engines, and more particularly hydrogen assisted jet ignition (HAJI) devices for improving combustion efficiency. In the present specification the term “hydrogen” is intended to include hydrogen and other fast-burning fuels. The benefits from the lean combustion approach are theoretically explained as follows. The excess air improves the engine's thermal efficiency by increasing the overall specific heats' ratio, by decreasing the energy losses from dissociation of the combustion products, and by reducing the thermal losses to the engine cooling system. In addition, as the flame temperature drops with decreasing fuel air ratio, the NOx production is exponentially reduced and the excess air may promote a more complete reaction of CO and hydrocarbon fuel emission from crevices and quench layers. It further discloses that the effect of changing the main chamber fuel composition for the range of 1=1 to 3.5 at full throttle (full power) and smaller ranges at part throttle was studied and that even at full throttle it was possible to reduce the work per cycle wc (and the torque) to no load quantities by increasing the relative air/fuel ratio; whereas the lean limit for this engine with normal ignition is shown to occur at 1=1.64, there exists no lean limit with hydrogen assisted jet ignition, HAJI, within the usable range of wc.

EP 0 770 171 B1 discloses that many attempts have been made to improve combustion efficiency. Such attempts included fuel stratification with a rich mixture in the spark plug region, divided or prechamber engines alone or in combination with stratification, and hydrogen enrichment of the whole fuel charge. None of these attempts have been entirely successful and the problems referred to above remain in evidence.

### SUMMARY

The object of the invention is to configure and arrange a combustion procedure for an Otto gas engine in such a manner that a higher rate of combustion is achievable.

According to the invention, the aforesaid object is achieved in that a) the loaded gas air mixture is choked with hydrogen, i.e. the hydrogen is added to the air gas mixture or b) the combustion chamber is directly charged with hydrogen, in an amount of at most X % of the volume of the loaded gas as a proportion of the gas air mixture in dependency of a value lambda λ according to the following table, whereby this loaded mixture of hydrogen, air and gas is adjusted to a maximum value lambda λ of Y, according to the following table:

| X [%] | 3.0 | 8.0 | 13.0 | 33.0 | 50.0 | 80.0 |
|---|---|---|---|---|---|---|
| Y | 1.8-2.1 | 1.85-2.3 | 1.9-2.4 | 2.2-2.8 | 2.5-3.5 | 3.7-5.1 |

### BRIEF DESCRIPTION OF THE DRAWINGS

FIG. 1 shows a schematic diagram of a supply chain of an engine generator unit with a H2 reformer;

FIG. 2 shows a schematic diagram similar to FIG. 1 with an electrically driven compressor;

FIG. 3 shows a schematic diagram of a supply chain of an engine generator unit with a gas converter; and

FIG. 4 shows a chart illustrating an exemplary variation of the parameter Y (or λ) with the parameter X.

### DETAILED DESCRIPTION

The maximum value lambda λ is defined as a range between the two values mentioned in the second line of this table. For example, in case of an amount of at most 3% hydrogen of the volume of the loaded gas the maximum value lambda λ is between 1.8 and 2.1.

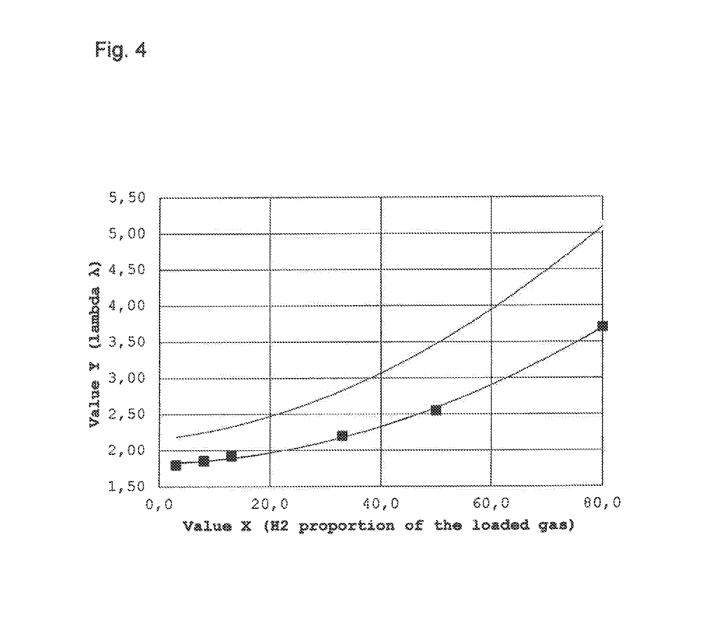

Further values for other amounts of hydrogen except the six values mentioned in the table above can be derived from the chart in FIG. 4. In this case, the additional gas proportion except hydrogen is methane. The combustion speed is adopted to be laminar with 15 cm/s.

The Δ-graph is the top of the range for value Y and the □-graph is the bottom of the range for value Y, both in dependency of value X.

To allocate a highly lean mixture leads to a combustion having a lower NOx (nitrogen oxide) portion and an increased rate of combustion. The increased rate of combustion allows a delayed ignition point, which leads to a higher degree of efficiency.

In case of for example 3% hydrogen the value lambda λ should be 2.01 or less, i.e. the loaded mixture of hydrogen, air and gas can always be richer than the mentioned value Y (2.01), because a richer mixture is basically better ignitable than a leaner mixture. If the proportion of hydrogen is less than 3%, the mixture should be richer than said value Y (2.01) to allow a good ignition, i.e. a high rate of combustion.

The mentioned values X and Y are six examples for the one skilled in the art as a basis for the adjustment of the values X and Y in a manner that the loaded mixture of hydrogen, air and gas is as lean as possible.

Even a higher proportion of hydrogen in the amount of 100% is marketable, though other sources for hydrogen as claimed are necessary. In this case, the value lambda λ should be at most 9.8. As mentioned before, in case of less than 100% hydrogen, the mixture has to be a little richer than Y=9.8. In case of 80% hydrogen it has to be no leaner than 8.60.

For all values mentioned before a deviation of +/−15% is possible, because of the further circumstances and conditions of the combustion.

The hydrogen increases the rate of combustion and thus the efficiency of the engine. Additionally to this the very lean gas-air mixture in the combustion chamber having a value lambda λ above 1.81 leads to a combustion with a lower NOx (nitrogen oxide) portion. The increased rate of combustion allows a later point of ignition, which leads to a higher degree of efficiency. Further efficiency asset results in part from the methane for the oxidation reaction R3, R3′, because there is energy recharged with hydrogen, produced by using exhaust gas energy.

The efficiency of the H2 production by a chemical reaction is not subject to restrictions like a thermo dynamic cyclic process. Therefore, the thermal exhaust energy used in this chemical process is reformed with a much better degree of efficiency, which leads to a better degree of efficiency overall.

Moreover, recharging this produced hydrogen leads to a reduction of nitrogen oxide (NOx) and formaldehyde, i.e. methanal (CH₂O) emissions, because the added hydrogen has a catalytic effect on the combustion. For this, the efficiency of the engine is increased, too.

It can also be an advantage if the engine generating an exhaust gas stream is having a thermal reformer as source, said thermal reformer converting water into hydrogen according to the following reactions:

MO_{red}+H2O<<->>MO_{OX}+H2, R1:

MO_{OX}<<->>MO_{red}+O2, R2:

and that the reformer is supplied with water and with heat from at least a part of the exhaust gas stream and that there are additional heating means, said heating means being powered by a part of the gas the engine is powered with in order to achieve the following exothermic oxidation reaction:

CH4+O2<<->>2H₂O+CO₂, or R3:

CₙHₘ+_{(n/2)}O2<<->>_{(m/2)}H2+ₙCO, R3′:

whereby the heating means are thermodynamically coupled to the reformer and are additionally heating the reformer.

Another procedure is possible, in which the engine generating an exhaust gas stream is having a converter, said converter converting higher HCs of the available gas to hydrogen, said HCs consisting of n carbon atoms and m hydrogen atoms according to at least one of the following reactions:

CₙHₘ+ₙH2O<<->>_{(m/2+n)}H2+CO,

CₙHₘ+_{(n/2)}O2<<->>_{(m/2)}H2+ₙCO,

CₙHₘ+ₙCO2<<-><_{{m/2)}H2+₂ₙCO,

whereby the converter is supplied with water, gas and with heat from at least a part of the exhaust gas stream.

Alternatively, it can be advantageous if having a thermal reformer and additionally a converter is being used to generate hydrogen.

Additionally, it can be advantageous if at least one compressor for loading said air-gas-mixture is driven via a motor, for example electrically. For this, the connected exhaust gas turbine can be eliminated. Therefore, the exhaust gas has a temperature that is 100° C. to 150° C. higher when entering the reformer. This higher temperature serves an improved operation of the reformer or the respective reactor in such that the heating means can generate less heating output.

It can be advantageous if the engine has an exhaust gas turbine and at least one further generator for generating power, said further generator being driven mechanically via the exhaust gas turbine, said exhaust gas turbine being positioned downstream to the source. The energy available from the exhaust gas can be gained in this stage and used to generate energy for heating or powering processes.

Additionally, it can be advantageous if only higher HCs, which have at least two or three carbon atoms, are converted in the converter. For optimization the methane number of the available gas it is more efficient to convert higher HCs first, i.e. methane itself must not be converted and therefore be joked with hydrogen.

Other advantages and details of the invention are explained in the claims and in the description as well as shown in the figures.

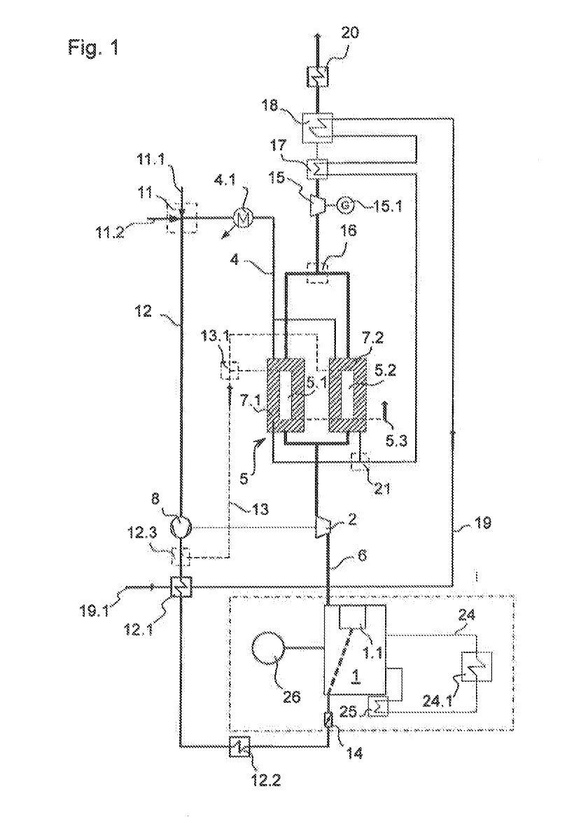

The schematic diagram in FIG. 1 shows the supply chain of a spark-ignited gas engine 1 with an air-gas mixture.

Starting from a gas mixer 11 at which the ambient air is mixed with the main combustion gas via an air port 11.1 and a gas port 11.2, a fuel duct 12 is conducted via a compressor 8 and a fuel cooler 12.2 to the gas engine 1 or to a combustion chamber 1.1 of the gas engine 1. A throttle valve 14 that is controlled based on the output of the gas engine 1 is provided in this fuel duct 12 immediately upstream to the gas engine 1. The gas engine 1 is connected to a generator 26, for example as part of a genset.

The gas engine 1 comprises an exhaust gas duct 6 in which an exhaust gas turbine 2 is provided downstream to the gas engine 1 that is used to drive the above-mentioned compressor 8. After passing through the exhaust gas turbine 2, the exhaust gas is conducted through a reformer 5 where it dissipates heat to the reformer 5 or a first reactor 5.1 or a second reactor 5.2, respectively. The exhaust gas passes the reformer 5, in parallel, via two separate exhaust gas streams that are coupled or controlled, respectively, via a valve 16 for exhaust gas, and associated with the respective reactor 5.1, 5.2. The valve 16 for exhaust gas is followed by a heat exchanger or superheater 17, respectively, and a downstream evaporator 18 for a water circuit 19 described below. An exhaust gas heat exchanger 20 is provided downstream before the exhaust gas is carried off to the exhaust system not shown here.

The water circuit or water duct 19 with the water port 19.1 is provided for supplying the reformer 5 with water for producing hydrogen. First, the water carried in it is preheated by a heat exchanger 12.1 for water coupled to the fuel duct 12, wherein the heat is taken from the compressed exhaust gas-air mixture. Then the water is heated in the evaporator 18 mentioned above, and the vapor is overheated accordingly in the downstream superheater 17 before it is returned to one of the two reactors 5.1, 5.2 of the reformer 5 via a respective valve 21 for water, i.e. steam. The hydrogen that is produced during reformation is fed to the mixer 11 via a hydrogen duct 4 and a condenser 4.1. The oxygen generated during hydrogen generation is carried off into the environment via a waste gate 5.3.

In order to achieve the temperatures required in the respective reactor 5.1, 5.2 or in the reformer 5, respectively, the respective reactor 5.1, 5.2 additionally comprises heating means 7.1, 7.2 that are also supplied with the air-gas mixture fed to the gas engine 1. For this purpose, the fuel duct 12 comprises a fuel valve 12.3 via which the required air-gas mixture is supplied via a fuel duct 13 and an air-gas valve 13.1 to the respective reactor 5.1, 5.2 or the respective heating means 7.1, 7.2. The Co2 exhaust gas that is produced when operating the respective heating means 7.1, 7.2 is carried off via the waste gate 5.3.

In addition, the gas engine 1 comprises a cooling circuit 24 with a cooling water heat exchanger 24.1 for cooling the gas engine 1. The cooling circuit 24 is also connected to an oil cooling exchanger 25.

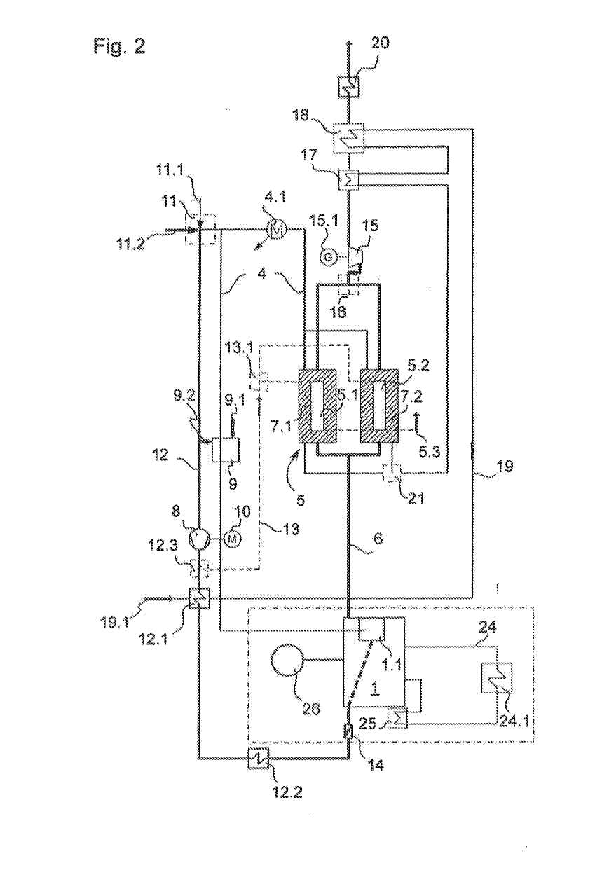

According to the functional diagram shown in FIG. 2, the compressor 8 is driven by an electric motor 10. The connected exhaust gas turbine 2 as shown in FIG. 1 is eliminated. For this, the exhaust gas, when it enters the reformer 5, has a temperature that is 100° C. to 150° C. higher. This higher temperature serves improved operation of the reformer 5 or the respective reactor 5.1, 5.2 in such that the heating means 7.1, 7.2 have to generate less heating output.

Alternatively, there is an exhaust gas turbine 15 positioned downstream to the reformer 5 with a connected generator 15.1 for generating power. This power can be used for further heating means connected to the reformer 5 or the superheater 17 or the evaporator 18, for example.

In addition, there is a mixing section 9 within the hydrogen duct 4 in which ambient air or gas is admixed to the hydrogen via an air port 9.1 and a gas-port 9.2 to obtain a hydrogen-gas or a hydrogen-gas-air mixture the combustion chamber 1.1 is loaded with.

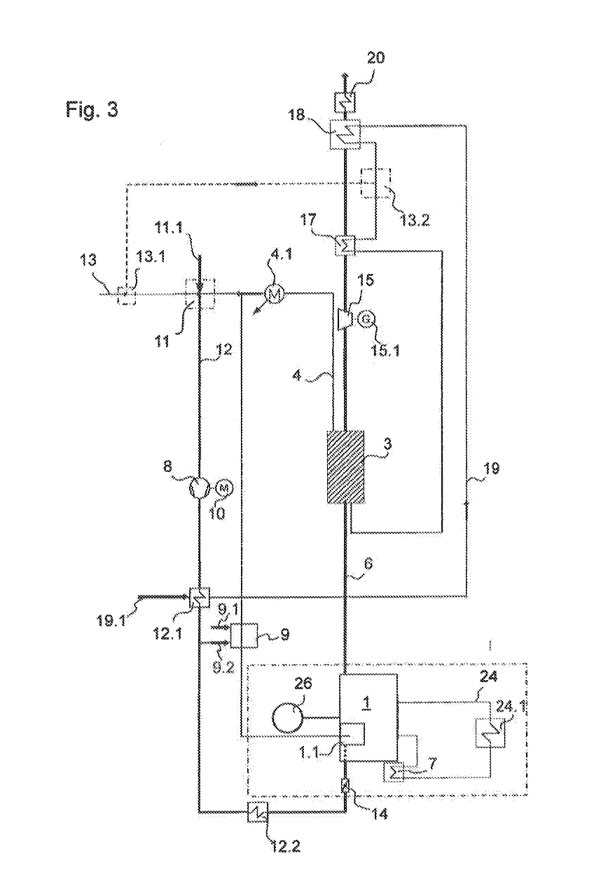

The schematic diagram in FIG. 3 shows the supply chain of a spark-ignited gas engine 1 with a gas converter.

Starting from the gas mixer 11 at which the ambient air is added via the air port 11.1 and mixed with the combustion gas, provided via the gas duct 13, the fuel duct 12 is conducted via the compressor 8 and the fuel cooler 12.2 to the spark-ignited gas engine 1 or to a combustion chamber 1.1 of the spark-ignited gas engine 1. The throttle valve 14 that is controlled based on the output of the spark-ignited gas engine 1 is provided in this fuel duct 12 immediately upstream of the spark-ignited gas engine 1.

The compressor 8 is driven by an electric motor 10. Therefore, there is no need for a connected exhaust gas turbine. The exhaust gas, when it enters a reformer 3 described below, has a temperature that is 100° C. to 150° C. higher as in case of an exhaust gas turbine. This higher temperature contributes to the enhanced operation of the reformer 3.

The spark-ignited gas engine 1 comprises the exhaust gas duct 6, in which the reformer 3 for gas is provided downstream to the spark-ignited gas engine 1. The heat of the exhaust gas is in part dissipated to the reformer 3 via a heat exchanger not shown here.

Downstream to the reformer 3, the exhaust gas turbine 15 is provided with a generator 15.1 coupled to it. Further expansion of the exhaust gas generates electricity that can also be used for the motor 10.

The exhaust gas turbine 15 is followed by the heat exchanger or superheater 17 and the evaporator 18 for a water circuit 19 described below. The exhaust gas heat exchanger 20 is provided downstream before the exhaust gas is carried off to the exhaust system not shown here.

The water circuit or water duct 19 with the water port 19.1 is provided for supplying the reformer 3 with water vapor for producing reform gas. First, the water carried in it is preheated by the water heat exchanger 12.1 coupled to the fuel duct 12, wherein the heat is taken from the compressed exhaust gas-air mixture. Then the water is heated in the evaporator 18 mentioned above, and the vapor is overheated accordingly in the downstream superheater 17 before it is discharged into the reformer 3.

A gas-steam mixing point 13.2 for adding combustion gas to the water vapor is provided between the evaporator 18 and the superheater 19. The mixing point 13.2 is connected to a gas duct 13 via the gas valve 13.1 for gas.

The reform gas that is produced during reformation can be fed to the mixer 11, and thus to the air-gas mixture, for combustion in the spark-ignited gas engine 1 via a reform gas duct 4 and a condenser 4.1.

There is a mixing section 9 within the reform gas duct 4 with a air port 9.1 and a gas port 9.2 which allows mixing combustion gas and/or air to the reform gas before this mixture is injected into the combustion chamber 1.1.

1-7. (canceled)

8. A method for operating an engine comprising:
supplying the engine with gas;
supplying the engine with hydrogen from a hydrogen source;
charging a combustion chamber of the engine with a first amount of loaded gas, the loaded gas including a mixture of air and the gas;
delivering, to the combustion chamber, a second amount of hydrogen that is a predetermined fraction X of the first amount, the predetermined fraction being selected to achieve a predetermined ratio λ of an actual amount of the air in the combustion chamber and a stoichiometric amount of the air in the combustion chamber, the hydrogen and the loaded gas forming a loaded gas mixture; and
igniting the loaded gas mixture in the combustion chamber.

9. The method of claim 8, wherein the hydrogen source is a thermal reformer and the method further includes:
supplying water to the thermal reformer;
heating the thermal reformer using at least a part of an exhaust gas stream from the combustion chamber; and
converting water into the hydrogen in the thermal reformer.

10. The method of claim 9, wherein heating includes:
supplying a portion of the gas to a heater;
thermodynamically coupling the heater and the thermal reformer; and
combusting the portion of the gas in the heater for heating the thermal reformer.

11. The method of claim 9, further including:
driving an exhaust gas turbine using exhaust gas from the thermal reformer;
driving a generator using the exhaust gas turbine; and
generating power using the generator.

12. The method of claim 8, further including:
supplying water to a converter;
supplying a portion of the gas to the converter;
supplying heat from an exhaust gas stream from the combustion chamber to the converter; and
converting higher hydrocarbons to the hydrogen in the converter.

13. The method of claim 12, wherein the higher hydrocarbons include at least two carbon atoms.

14. The method of claim 8, wherein charging the combustion chamber further includes:
driving a compressor using an electric motor;
compressing the air using the compressor; and
mixing the compressed air with the gas.

15. The method of claim 8, wherein X and λ are correlated as shown below.

| X % | 3.0 | 8.0 | 13.0 | 33.0 | 50.0 | 80.0 |
|---|---|---|---|---|---|---|
| λ | 1.8-2.1 | 1.85-2.3 | 1.9-2.4 | 2.2-2.8 | 2.5-3.5 | 3.7-5.1 |

16. An engine, comprising:
a combustion chamber;
a gas port configured to supply the engine with gas;
a gas mixer configured to generate a first amount of loaded gas and direct the first amount to the combustion chamber, the loaded gas including a mixture of air and the gas; and
a hydrogen source configured to supply the engine with a second amount of hydrogen that is a predetermined fraction X of the first amount, the predetermined fraction being selected to achieve a predetermined ratio λ of an actual amount of the air in the combustion chamber and a stoichiometric amount of the air in the combustion chamber, the hydrogen and the loaded gas forming a loaded gas mixture in the combustion chamber.

17. The engine of claim 16, further including:
a thermal reformer configured to generate the hydrogen from water;
a water circuit configured to supply the water to the thermal reformer; and
an exhaust gas duct configured to direct an exhaust gas stream from the combustion chamber to the thermal reformer, the exhaust gas stream being configured to heat the thermal reformer.

18. The engine of claim 17, wherein the thermal reformer includes at least one reactor configured to be heated by the exhaust gas stream.

19. The engine of claim 18, further including:
a heater configured to heat the at least one reactor; and
a fuel valve configured to direct a portion of the loaded gas to the heater for combustion in the heater, the fuel valve being configured to direct a remaining portion of the loaded gas to the combustion chamber.

20. The engine of claim 17, further including:
an exhaust gas turbine configured to receive the exhaust gas stream, the exhaust gas stream driving the exhaust gas turbine; and
a generator coupled to the exhaust gas turbine, the generator being configured to be driven by the exhaust gas turbine and generate power.

21. The engine of claim 20, wherein the exhaust gas turbine is a first exhaust gas turbine, and the engine further includes:
a second exhaust gas turbine configured to receive the exhaust gas stream, the exhaust gas stream driving the second exhaust gas turbine, wherein
the first exhaust gas turbine is configured to receive he exhaust gas stream from the thermal reformer, and
the second exhaust gas turbine is configured to receive the exhaust gas stream from the combustion chamber and to direct the exhaust gas stream to the thermal reformer.

22. The engine of claim 21, further including:
a compressor coupled to the second exhaust gas turbine and configured to compress the loaded gas before directing the loaded gas to the combustion chamber.

23. The engine of claim 20, further including:
an electric motor; and
a compressor configured to be driven by the electric motor, the compressor further being configured to compress the loaded gas before directing the loaded gas to the combustion chamber.

24. The engine of claim 16, further including:
a converter configured to generate the hydrogen from the gas
a gas duct configured to supply a portion of the gas from the gas port to the converter; and
an exhaust duct configured to direct an exhaust gas stream from the combustion chamber to the converter, wherein the converter is configured to convert higher hydrocarbons to the hydrogen in the converter.

25. The engine of claim 24, wherein the higher hydrocarbons include at least two carbon atoms.

26. The engine of claim 16, wherein the hydrogen source is configured to deliver the hydrogen directly to the combustion chamber.

27. The engine of claim 16, wherein the gas port is a first gas port and the engine further includes
a second gas port; and
a mixing section configured to:
receive a portion of the gas from the first gas port;
receive air from an air port associated with the mixing section;
receive the hydrogen from the hydrogen source;
mix the air, the portion of the gas and the hydrogen to form the loaded gas mixture; and
deliver the loaded gas mixture to the combustion chamber.
